(19) United States
(12) Patent Application Publication
(10) Pub. No.: US 2020/0187205 A1
(43) Pub. Date: Jun. 11, 2020

(54) USER EQUIPMENT AND RESOURCE ELEMENT MAPPING METHOD

(71) Applicants: NTT DOCOMO, INC., Tokyo (JP); DOCOMO INNOVATIONS, INC., Palo Alto, CA (US)

(72) Inventors: Yuichi Kakishima, Tokyo (JP); Shohei Yoshioka, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 16/638,035

(22) PCT Filed: Aug. 8, 2018
(86) PCT No.: PCT/US2018/045794

§ 371 Date: Feb. 10, 2020

Related U.S. Application Data
(60) Provisional application No. 62/543,840, filed on Aug. 10, 2017.

(51) Int. Cl. H04W 72/04; H04B 1/713; H04L 1/18

(52) U.S. Cl. CPC H04W 72/0446; H04L 1/1812; H04B 1/713

(57) ABSTRACT

A user equipment (UE) in a wireless communication system where frequency hopping is applied includes a processor and a memory. The processor determines a scheme for resource element (RE) mapping over a slot in which the frequency hopping is applied. The scheme indicates order of resources mapped to one or more codeblocks (CBs). The processor further maps data for the CBs to REs in accordance with the indicated order. The order of resources is determined based on a frequency resource, a time resource, and a layer. When the CBs include a first and a second CB, the first CB is mapped to the REs in a first sub slot of the slot and the second CB is mapped to the REs in a second sub slot of the slot that has a different frequency resource from the first sub slot.

### TECHNICAL FIELD

One or more embodiments disclosed herein relate to a user equipment in a wireless communication system and a resource element (RE) mapping method in the user equipment.

### BACKGROUND

In Long Term Evolution (LTE)/LTE-Advanced (LTE-A), downlink and uplink data is divided into more than or equals to one codewords (CWs) that is further composed of more than or equals to one codeblocks (CBs). The CW is a unit of re-transmission of Hybrid Automatic Repeat reQuest (HARQ). An LTE/LTE-A packet (CW mapping) has been designed to achieve Multiple-Input and Multiple-Output (MIMO) spatial diversity gain. More specifically, a modulated signal sequence is mapped in order of MIMO layer, subcarrier (frequency), and Orthogonal Frequency-Division Multiplexing (OFDM) symbol (time) for the downlink transmission.

To determine how the signal sequence is mapped to physical resources such as REs, the priority order of time, frequency, and layer may be designed from the major candidates as follows: (1) time, frequency, and layer; (2) time, layer, and frequency; (3) frequency, time, and layer; (4) frequency, layer, and time; (5) layer, time, and frequency; and (6) layer, frequency, and time, in descending order. For example, assuming that a Transmission and Reception Point (TRP) transmits a data sequence to a User Equipment (UE) with the above pattern (4) via two MIMO Layers 1 and 2 as shown in FIG. 1, the data sequence may be mapped as shown in FIG. 2. In this example, the data sequence is mapped, along the frequency axis direction, to REs of the first time resource of Layers 1 and 2, and then mapped to the following time resources of those layers in a similar manner. It is known that the order may affect the quality of transmission, e.g., time, frequency, or layer-domain diversity.

In NR, CB group (CBG)-level HARQ is introduced to allow for granular retransmission control. Moreover, in Physical Uplink Shared Channel (PUSCH) transmission, frequency hopping is introduced for achieving frequency diversity gain. As shown in FIG. 3, a data sequence is mapped to different frequency resources in a single slot (i.e., two sub slots each having a different frequency resource) except predetermined regions such as reference signals (RSs), which allows a receiver to receive data within one sub slot successfully received in a strong signal condition while recovering, by performing error corrections, the lost data of the other sub slot in a weak signal condition.

However, any scheme has not been proposed for RE mapping in order to improve frequency diversity gain under the situation where frequency hopping is introduced.

### CITATION LIST

### Non-Patent Reference

[Non-Patent Reference 1] 3GPP, TS 36.211 V 14.2.0
[Non-Patent Reference 2] 3GPP, TS 36.213 V 14.2.0

### SUMMARY

One or more embodiments of the invention relate to a UE in a wireless communication system where frequency hopping is applied. The UE may include a processor and a memory. The processor may determine a scheme for resource element (RE) mapping over a slot in which the frequency hopping is applied. The scheme indicates order of resources mapped to one or more codeblocks (CBs). The processor may map data for the CBs to REs in accordance with the indicated order.

Other embodiments and advantages of the present invention will be recognized from the description and figures.

### BRIEF DESCRIPTION OF THE DRAWINGS

FIG. 1 shows a diagram of a wireless communication system for MIMO transmission.

FIG. 2 shows an example of RE mapping in the wireless communication system shown in FIG. 1.

FIG. 3 shows frequency hopping introduced for PUSCH transmission in an NR system.

FIG. 4 shows a configuration of a wireless communication system according to one or more embodiments of the invention.

FIG. 5 shows a diagram for explaining CB segmentation.

FIGS. 6A-6H each show an RE mapping scheme according to one or more embodiments of the present invention.

FIG. 7 shows a flowchart of an operation example of RE mapping according to one or more embodiments of the invention.

FIG. 8 shows a schematic configuration of a TRP according to one or more embodiments of the present invention.

FIG. 9 shows a schematic configuration of an UE according to one or more embodiments of the present invention.

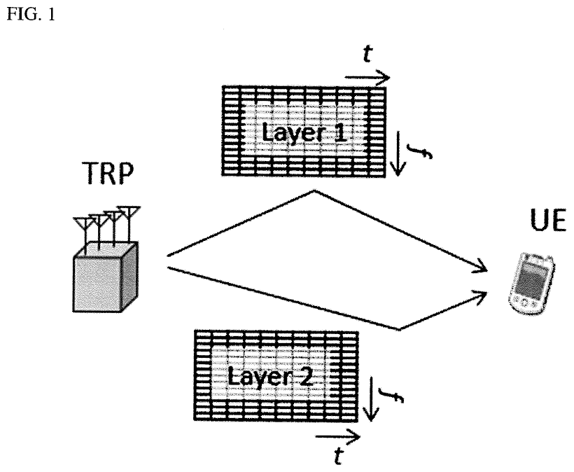

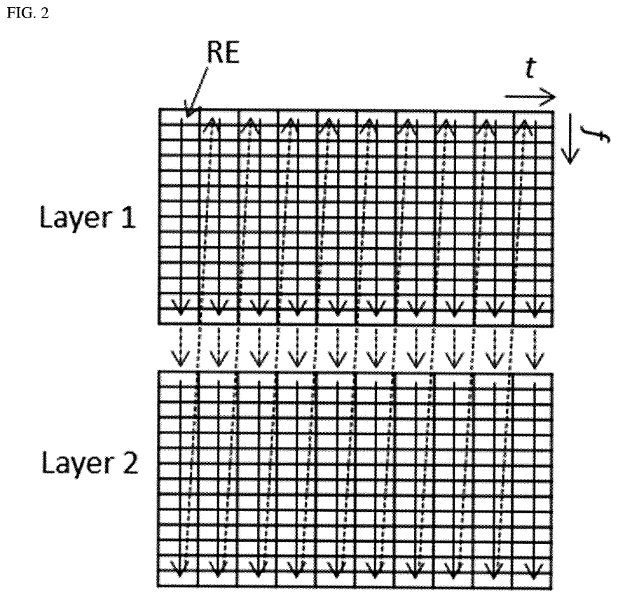

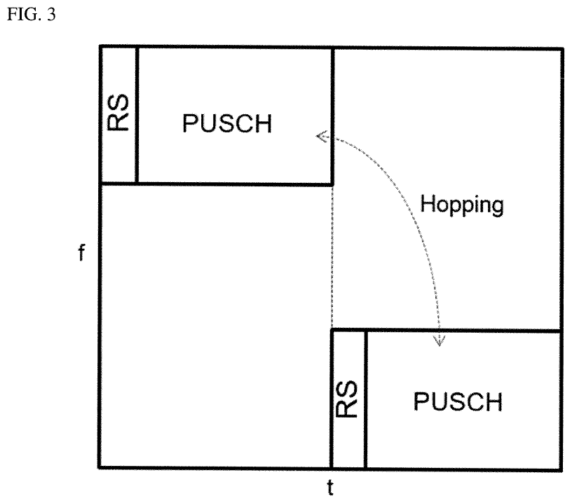

### DETAILED DESCRIPTION

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

FIG. 4 is a wireless communications system 1 according to one or more embodiments of the invention. The wireless communication system 1 includes a UE 10, a TRP 20, and a core network 30. The wireless communication system 1 may be an NR system. The wireless communication system 1 is not limited to the specific configurations described herein and may be any type of wireless communication system such as an LTE/LTE-Advanced (LTE-A) system.

The TRP 20 may communicate uplink (UL) and downlink (DL) signals with the UE 10 in a cell of the TRP 20. The DL and UL signals may include control information and user data. The TRP 20 may communicate DL and UL signals with the core network 30 through backhaul links 31. The TRP 20 may be referred to as a base station (BS). The TRP 20 may be gNodeB (gNB).

The TRP 20 includes antennas, a communication interface to communicate with an adjacent TRP 20 (for example, X2 interface), a communication interface to communicate with the core network 30 (for example, S1 interface), and a Central Processing Unit (CPU) such as a processor or a circuit to process transmitted and received signals with the UE 10. Operations of the TRP 20 may be implemented by the processor processing or executing data and programs stored in a memory. However, the TRP 20 is not limited to the hardware configuration set forth above and may be realized by other appropriate hardware configurations as understood by those of ordinary skill in the art. Numerous TRPs 20 may be disposed so as to cover a broader service area of the wireless communication system 1.

The UE 10 may communicate DL and UL signals that include control information and user data with the TRP 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a Random Access Memory (RAM), a flash memory, and a radio communication device to transmit/receive radio signals to/from the TRP 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

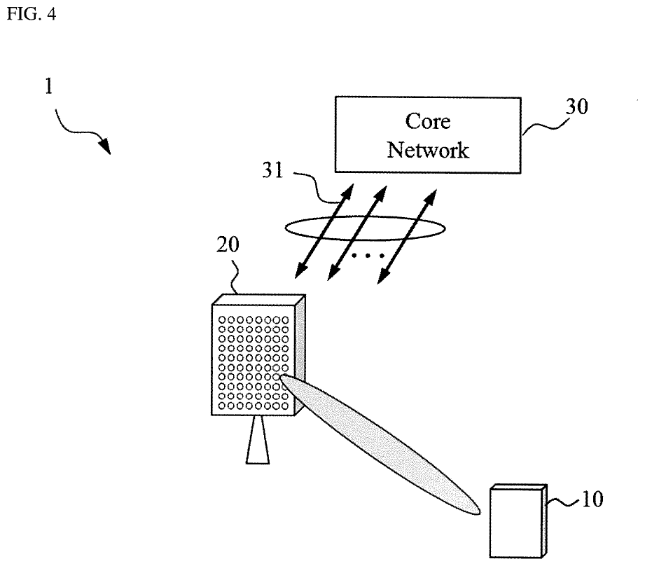

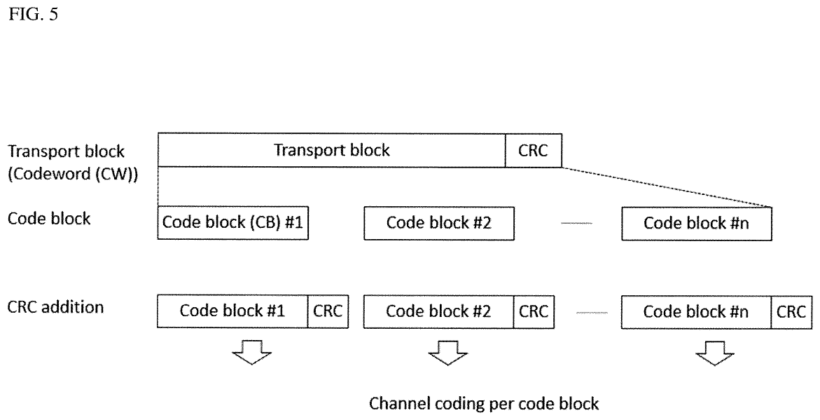

In one or more embodiments of the invention, the UE 10 may generate CWs by dividing transmission data. The CW is a data stream after channel coding process. The CW may be used as a unit of re-transmission or link adaptation under HARQ process. Additionally, as shown in FIG. 5, the UE 10 may generate one or more CBs by dividing the CW, which may also be used as a unit of re-transmission. In the NR system, the UE may perform HARQ process for each CW (CW-level HARQ) or for each CB (CBG-level HARQ).

Based on the generated CBs, the UE 10 may perform RE mapping to multiple layers, frequency resources, and time resources for PUSCH transmission. For example, the frequency resources may be subcarriers, and the time resources may be Orthogonal Frequency-Division Multiplexing (OFDM) symbols such as DFT-Spread-OFDM symbols. Transmission quality (diversity gains) may be different depending on mapping order of the multiple layers, the frequency resources, and the time resources.

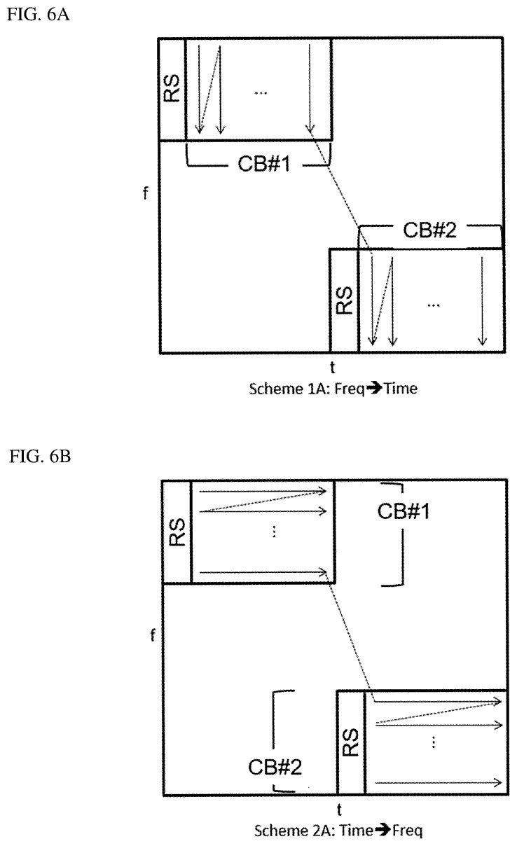

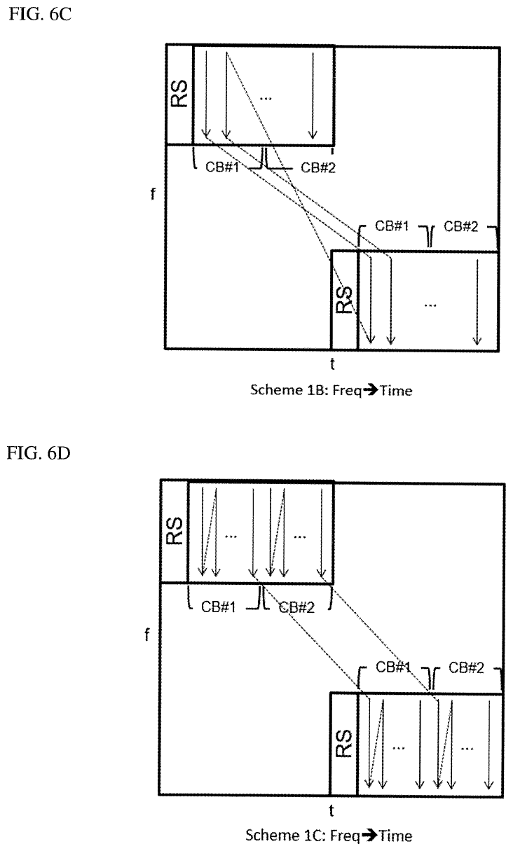

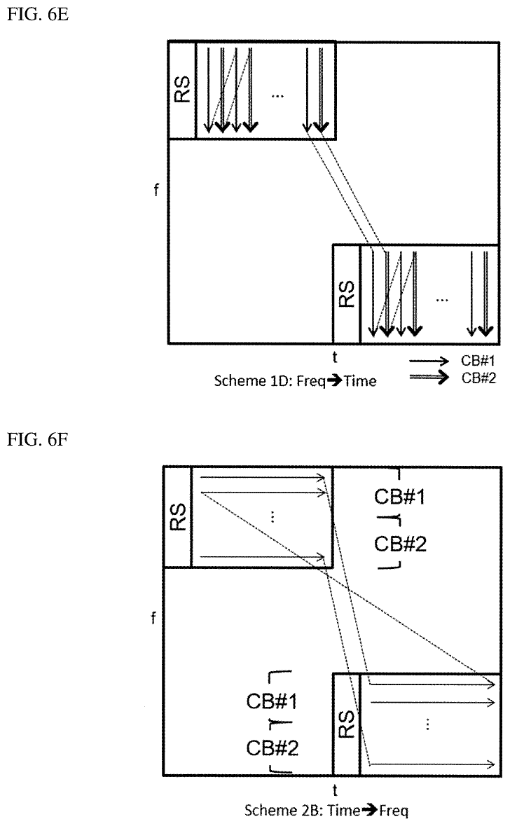

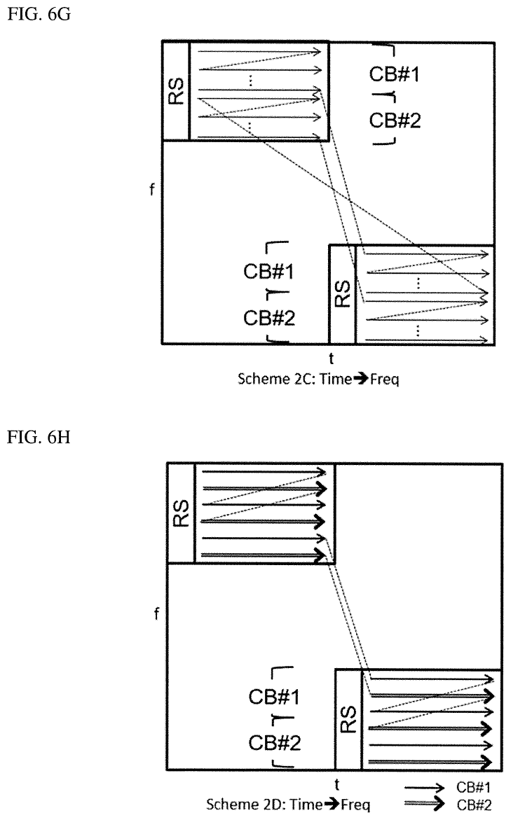

As shown in FIGS. 6A-6H, several RE mapping schemes are proposed in one or more embodiments of the present invention for a UE to transmit data in an NR system in which frequency hopping is introduced. Each scheme specifies how to map uplink data or CB to REs in a resource block consisting of a predetermined number of subcarriers and OFDM symbols (or DFT-s-OFDM symbols) with one or more layers. For illustration purposes, the following schemes are explained using two CBs CB #1 and CB #2 that form a single CW under a single layer configuration.

FIG. 6A shows an example of RE mapping according to one or more embodiments of the invention (hereinafter called “Scheme 1A”). In Scheme 1A, the UE 10 may perform RE mapping for CB #1 and CB #2 in the order of frequency and time. As shown in FIG. 6A, CB #1 is mapped to the REs in the first sub slot except a predetermined region reserved for RSs or other signals. More specifically, the uplink data sequence of CB #1 is first mapped, along the frequency axis direction, to the first time resource in the first sub slot of a single slot, and then mapped to the subsequent time resources in the first sub slot in a similar manner. Similarly, the data sequence of CB #2 is first mapped, along the frequency axis direction, to the first time resource in the second sub slot, which has a different frequency resource from the first sub slot, and then mapped to the subsequent time resources in the second sub slot in a similar manner.

According to this scheme, even when the signal condition of one sub slot is not good and causes data of the CB to be lost, the UE 10 can perform HARQ process on the lost CB only. Thus, this scheme may improve use efficiency of radio resources in the wireless communication system when CBG-level HARQ is used in the NR system. Additionally, this scheme allows a receiver such as a gNB to perform pipe-line operation for decoding the UL data because the gNB receiver may start the decoding immediately after all symbols for the first CB is received (fast data decoding). In other words, when one of the CBs is mapped at early OFDM symbols, the receiver can maximize the performance for such pipe-line operation.

FIG. 6B shows an example of RE mapping according to one or more embodiments of the invention (hereinafter called “Scheme 2A”). In Scheme 2A, the UE 10 may perform RE mapping for CB #1 and CB #2 in the order of time and frequency. As shown in FIG. 6B, CB #1 is mapped to the REs in the first sub slot except the predetermined region. More specifically, the uplink data sequence of CB #1 is mapped, along the time axis direction, to the first frequency resource or subcarrier in the first sub slot, and then mapped to the subsequent frequency resources in the first sub slot in a similar manner. Similarly, the uplink data sequence of CB #2 is mapped, along the time axis direction, to the first frequency resource or subcarrier in the second sub slot, and then mapped to the subsequent frequency resources in the second sub slot.

According to this scheme, like Scheme 1A, even when a bad signal condition in a sub slot causes part of the CB to be lost, the UE 10 can just retransmit the lost CB. As a result, use efficiency of radio resources may be improved when CBG-level HARQ is used in the NR system. Moreover, this scheme allows a UL data receiver such as a gNB to perform pipe-line operation for decoding UL data immediately after receiving all symbols for the first CB.

FIG. 6C shows an example of RE mapping according to one or more embodiments of the invention (hereinafter called “Scheme 1B”). In Scheme 1B, the UE 10 may perform RE mapping for CB #1 and CB #2 in the order of frequency and time so that each CB is mapped over two sub slots (i.e., frequency hopping). As shown in FIG. 6C, CB #1 is mapped over the first and the second sub slot so that the data sequence is first mapped, along the frequency axis direction, to the REs of the first time resource in the first sub slot, and then mapped to the first time resource in the second sub slot. When the data has reached the end of the time resource in the second sub slot, then the data is mapped to the second and subsequent time resources in the first and the second sub slot. CB #2 is also mapped over the first and the second sub slot in a similar manner as CB #1. In this example, CB #2 is mapped to the REs of the second half of each sub slot.

According to this scheme, frequency diversity gain can be achieved for all of the CBs mapped over the different frequency resources (i.e., frequency hopping) in the NR system. Additionally, a receiver such as a gNB may advantageously perform pipe-line operation for decoding the UL data when receiving all symbols for one CB. In other words, the performance of the gNB receiver may be improved by mapping one of the CBs at early OFDM symbols. This scheme may achieve better performance when the CW-level HARQ is used in the NR system.

FIG. 6D shows an example of RE mapping according to one or more embodiments of the invention (hereinafter called “Scheme 1C”). In Scheme 1C, similarly to Scheme 1B, the UE 10 may perform RE mapping for CB #1 and CB #2 in the order of frequency and time so that each CB is mapped over the two sub slots. Unlike Scheme 1B, CB #1 is first mapped, along the frequency axis direction, to the REs of the time resources in the first half of the first sub slot, and then mapped to the time resources in the first half of the second sub slot. Similarly, CB #2 is first mapped to the REs of the time resources in the second half of the first sub slot, and then mapped to the time resources in the second half of the second sub slot.

According to this scheme, all the CBs may be mapped for all of the frequency hopping resources, which achieves frequency diversity gain for all of the CB and better performance when the CW-level HARQ is used in the NR system. Further, this scheme also allows a receiver such as a gNB to perform pipe-line operation for decoding the UL data in response to receiving all symbols of one CB.

FIG. 6E shows an example of RE mapping according to one or more embodiments of the invention (hereinafter called “Scheme 1D”). In Scheme 1D, the UE 10 may perform RE mapping for CB #1 and CB #2 in the order of frequency and time so that each CB is mapped over two sub slots (i.e., frequency hopping). Similarly to Scheme 1C, CB #1 and CB #2 are mapped over the first and second sub slots. In Scheme 1D, however, CB #1 and CB #2 are alternately mapped to, along the frequency axis direction, to the time resources in each sub slot as shown in FIG. 6E. As a result, the data for all CBs is mapped to the entire slot.

According to this scheme, similarly to Schemes 1B and 1C, frequency diversity gain can be achieved for all of the CBs mapped over the different frequency resources (i.e., frequency hopping) in the NR system. This scheme may achieve better performance when the CW-level HARQ is used in the NR system.

FIG. 6F shows an example of RE mapping according to one or more embodiments of the invention (hereinafter called “Scheme 2B”). In Scheme 2B, the UE 10 may perform RE mapping for CB #1 and CB #2 in the order of time and frequency over the first and second time slots, i.e., different frequency resources. As shown in FIG. 6F, CB #1 is first mapped, along the frequency axis direction, to the first frequency resource in the first sub slot, and then mapped to the first frequency resource in the second sub slot. Subsequently, CB #1 is mapped to the frequency resource the next frequency resource in the first and second sub slots in a similar manner. On the other hand, CB #2 is mapped to the frequency resource next to the frequency resource where the last data of CB #1 is mapped in the first sub slot, and then mapped to the frequency resource next to the frequency resource where the last data of CB #1 is mapped in the second sub slot.

This scheme can achieve frequency diversity gain within each CB because sequential data for one CB may be transmitted over different frequency resources. This scheme may achieve better performance when the CW-level HARQ is used in the NR system.

FIG. 6G shows an example of RE mapping according to one or more embodiments of the invention (hereinafter called “Scheme 2C”). In Scheme 2C, similarly to Scheme 2B, the UE 10 may perform RE mapping for CB #1 and CB #2 in the order of time and frequency over different frequency resources (i.e., frequency hopping). Unlike Scheme 2B, the first half of CB #1 is mapped to the REs of the frequency resources in the first half of the first sub slot, and the second half of the CB #1 is mapped to the REs of the frequency resources in the first half of the second sub slot. On the other hand, the first half of CB #2 is mapped to the REs of the frequency resources in the second half of the first sub slot, and the second half of CB #2 is mapped to the REs of the frequency resources in the second half of the second sub slot.

Similarly to Scheme 2B, this scheme can achieve frequency diversity gain within each CB because sequential data for one CB may be transmitted over different frequency resources. This scheme may achieve better performance when the CW-level HARQ is used in the NR system.

FIG. 6H shows an example of RE mapping according to one or more embodiments of the invention (hereinafter called “Scheme 2D”). In Scheme 2D, the UE 10 may perform RE mapping for CB #1 and CB #2 in the order of time and frequency over different frequency resources. As shown in FIG. 6H, similarly to Scheme 2C, CB #1 and CB #2 are mapped over the first and the second sub slot. In Scheme 2D, however, CB #1 and CB #2 are alternately mapped in the frequency axis direction in each sub slot, as shown in FIG. 6H. As a result, the data for all CBs is mapped over the frequency resources used for the sub slots.

This scheme can achieve frequency diversity gain within each CB because sequential data for one CB may be transmitted over different frequency resources. This scheme may achieve better performance when the CW-level HARQ is used in the NR system.

In one or more embodiments of the invention, the UE 10 may perform RE mapping according to the schemes discussed above under the NR system where frequency hopping is applied for PUSCH transmission. The UE 10 may apply one of the schemes based on a signal from a gNB. Additionally, the UE 10 may change the schemes depending on HARQ schemes. For example, when the CW-level HARQ is used in the NR system, the UE 10 may apply either of the schemes 1B/1C/1D or 2B/2C/2D, and when the CBG-level HARQ is used, the UE 10 may apply the scheme 1A or 2A.

In one or more embodiments of the invention, the aforementioned schemes may be extended to multi-layer transmission cases including multi-CW transmission. For example, data mapping for layers may be made before, while, or after RE mapping is made with respect to time and frequency domains. Moreover, the discussed schemes may be applied to a case where a single CB or three or more CBs is/are transmitted.

In one or more embodiments of the invention, the UE 10 may apply and switch the above schemes according to implicit or explicit signaling. Such signaling may be performed by higher layer signaling such as Radio Resource Control (RRC) signaling and/or the lower layer signaling such as Downlink Control Information (DCI) and Media Access Control Control Element (MAC CE). Furthermore, the signaling according to one or more embodiments of the present invention may use a Master Information Block (MIB) and/or a System Information Block (SIB). For example, at least two of the RRC, the DCI, and the MAC CE may be used in combination as the signaling according to one or more embodiments of the invention.

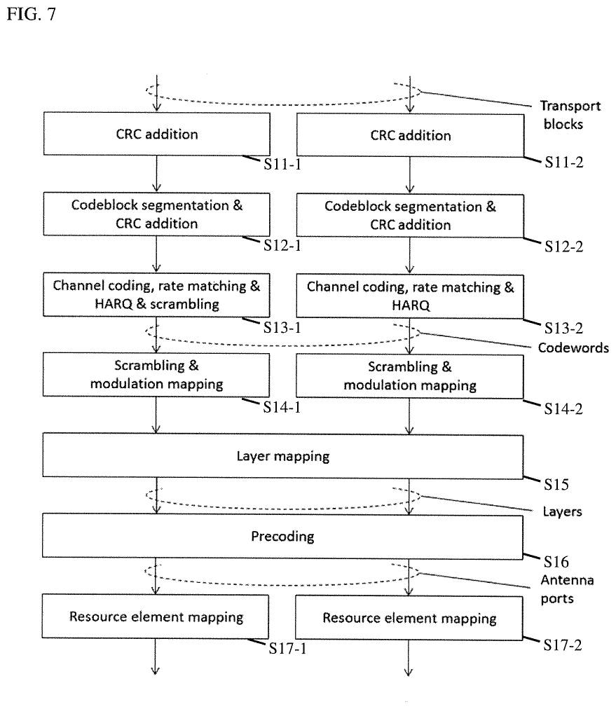

FIG. 7 shows a flowchart of an operation example of RE mapping according to one or more embodiments of the invention.

As shown in FIG. 7, at step S11-1 (S11-2), the UE 10 adds a CRC to a transport block. At step S12-1 (S12-2), the UE 10 performs CB segmentation and CRC addition so that the length of each CB matches a predetermined length specified by the 3GPP standard. At step S13-1 (S13-2), the UE 10 performs channel coding; rate matching; HARQ processing; and scrambling for the generated CB. At step S14-1 (S14-2), the UE 10 performs scrambling and modulation mapping.

At step S15, the UE 10 performs layer mapping for the CBs. In one or more embodiments of the invention, the UE 10 may determine which scheme is applied for RE mapping at this step. For example, the UE may choose one of the above schemes according to a signal from a gNB. Alternatively, the UE may apply one of the above schemes in a static manner. Subsequently, the UE 10 may perform precoding at S16, and then perform RE mapping according to the selected scheme at S17-1 (S17-2). In one or more embodiments of the invention, the UE 10 may determine which scheme is applied for RE mapping at this step.

(Configuration of TRP)

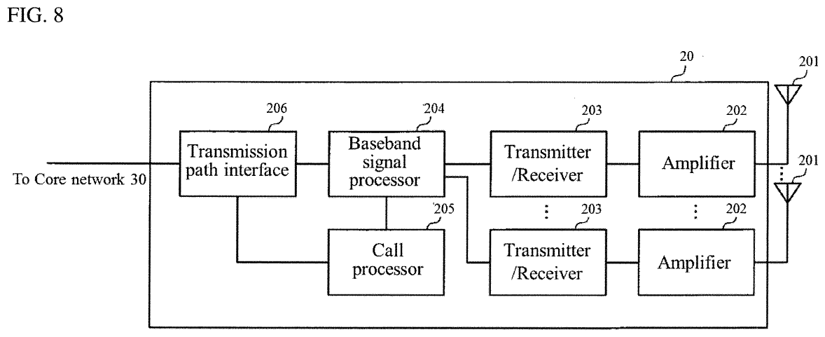

The TRP 20 according to one or more embodiments of the invention will be described below with reference to FIG. 8. FIG. 8 shows a schematic configuration of the TRP 20 according to one or more embodiments of the invention. The TRP 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the TRP 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the TRP 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the TRP 20, and manages the radio resources.

(Configuration of User Equipment)

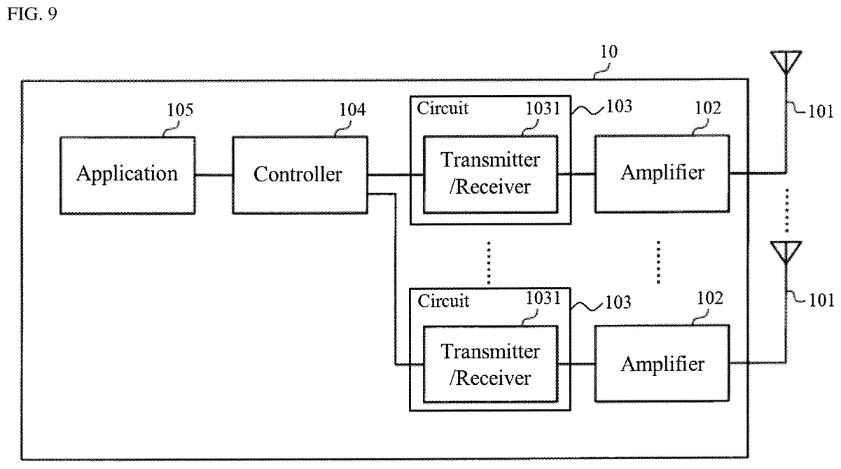

The UE 10 according to one or more embodiments of the invention will be described below with reference to FIG. 9. FIG. 9 shows a schematic configuration of the UE 10 according to one or more embodiments of the invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

One or more embodiments of the present invention may be used for each of the uplink and the downlink independently. One or more embodiments of the present invention may be also used for both of the uplink and the downlink in common.

Although the present disclosure mainly described examples of a channel and signaling scheme based on NR, the present invention is not limited thereto. One or more embodiments of the present invention may apply to another channel and signaling scheme having the same functions as NR such as LTE/LTE-A and a newly defined channel and signaling scheme.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A user equipment (UE) in a wireless communication system where frequency hopping is applied, the UE comprising:
a processor and a memory, wherein
the processor
determines a scheme for resource element (RE) mapping over a slot in which the frequency hopping is applied, wherein the scheme indicates order of resources mapped to one or more codeblocks (CBs); and
maps data for the CBs to REs in accordance with the indicated order.

2. The UE according to claim 1, wherein the order of resources is determined based on a frequency resource, a time resource, and a layer.

3. The UE according to claim 2, wherein when the CBs include a first and a second CB, the first CB is mapped to the REs in a first sub slot of the slot and the second CB is mapped to the REs in a second sub slot of the slot that has a different frequency resource from the first sub slot.

4. The UE according to claim 3, wherein each of the first and second CB is mapped to the REs in the order of frequency and time.

5. The UE according to claim 3, wherein each of the first and second CB is mapped to the REs in the order of time and frequency.

6. The UE according to claim 2, wherein when the CBs include a first and a second CB, the first and the second CB are mapped over a first sub slot and a second sub slot that has a different frequency resource from the first sub slot.

7. The UE according to claim 6, wherein each of the first and second CB is mapped to the REs in the order of frequency and time.

8. The UE according to claim 6, wherein each of the first and second CB is mapped to the REs in the order of time and frequency.

9. The UE according to claim 2, wherein the processor determines the order based on a type of re-transmission control.

10. The UE according to claim 9, wherein the type of re-transmission control is CW-level Hybrid Automatic Repeat Request (HARQ) and code block (CB)-level HARQ.

11. A method performed by a user equipment (UE) in a wireless communication system where frequency hopping is applied, the method comprising:
determining a scheme for resource element (RE) mapping over a slot in which the frequency hopping is applied, wherein the scheme indicates order of resources mapped to one or more codeblocks (CBs); and
mapping data for the CBs to REs in accordance with the indicated order.
